(19) United States
(12) Patent Application Publication
(10) Pub. No.: US 2026/0160535 A1
(43) Pub. Date: Jun. 11, 2026

(54) TAPE MEASURE WITH ELECTRICIAN REFERENCE MARKINGS

(71) Applicant: Cesar Reyes, Arlington, TX (US)

(72) Inventor: Cesar Reyes, Arlington, TX (US)

(21) Appl. No.: 18/973,833

(22) Filed: Dec. 9, 2024

(51) Int. Cl. G01B 3/1084; G01B 3/1003

(52) U.S. Cl. CPC G01B 3/1084; G01B 3/1003

(57) ABSTRACT

A measuring device for measuring lengths and providing reference information for use by an electrician includes a measuring tape with numbers indicating distances from a free end of the measuring tape. The numbers are arranged in a first subset and a second subset. The numbers of the first subset are colored to indicate wire colors and electrical phases associated with circuits of matching number of a low-voltage electrical panel. The numbers of the second subset are colored to indicate wire colors and electrical phases associated with circuits of matching number of a high-voltage electrical panel. Indicia providing reference information for bending electrical conduit is also included.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to measuring tools and more particularly pertains to a new measuring tool for measuring lengths and providing reference information for use by an electrician.

### (2) Description of Related Art Including Information Disclosed Under 37 CFR 1.97 and 1.98

The prior art describes various measurement tools for measuring lengths and various reference tools for electricians installing wiring in an electrical panel. U.S. Patent Pub. No. 2010/0139110 discloses a tape measure in which numbers indicating lengths along the tape measure are color coded to refer to circuit numbers in both low-voltage electrical panels and high-voltage electrical panels. Additional markings indicate the phase of the circuits. However, the prior art fails to describe such a tape measure which includes multiple sets of numbers for referencing low- and high-voltage electrical panel circuits via color code. The prior art further fails to describe such an apparatus which includes reference markings that communicate an arc length that would result from bending electrical conduit of varying diameters in a 90-degree bend via a conduit bending tool.

### BRIEF SUMMARY OF THE INVENTION

An embodiment of the disclosure meets the needs presented above by generally comprising a measuring tape which is elongated and has a first surface and a second surface positioned opposite each other. The measuring tape further has a first longitudinal edge and a second longitudinal edge positioned opposite each other and a free end which extends between the first longitudinal edge and the second longitudinal edge. Measurement indicia is coupled to the first surface of the measuring tape to indicate distances from the free end. The measurement indicia include a plurality of numbers including a first subset of numbers and a second subset of numbers. The numbers of each of the first and second subsets of numbers increasing consecutively away from the free end of the measuring tape. The numbers of the first subset of numbers are colored in a repeated pattern of two numbers in a first color, two numbers in a second color, and two numbers in a third color. The numbers of the second subset of numbers are colored in a repeated pattern of two numbers in a first color, two numbers in a second color, and two numbers in a third color.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a measuring device according to an embodiment of the disclosure.

FIG. 2 is a rear perspective view of an embodiment of the disclosure.

FIG. 3 is a top view of an embodiment of the disclosure.

FIG. 4 is a side view of an embodiment of the disclosure.

FIG. 5 is a top view of an embodiment of the disclosure.

FIG. 6 is a top view of an embodiment of the disclosure showing associations between measurement indicia of the embodiment and circuits of a low-voltage electrical panel.

FIG. 7 is a top view of an embodiment of the disclosure depicting how information is presented relevant to bending electrical conduit.

### DETAILED DESCRIPTION OF THE INVENTION

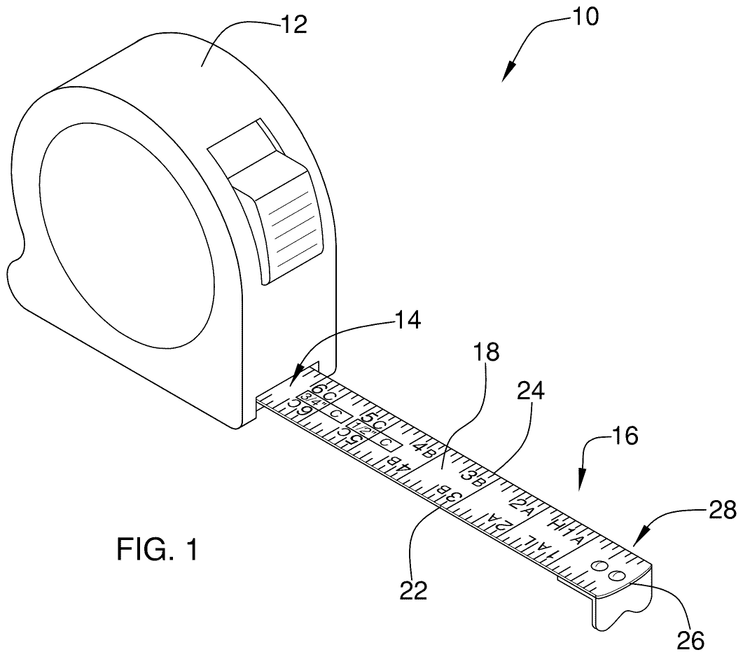

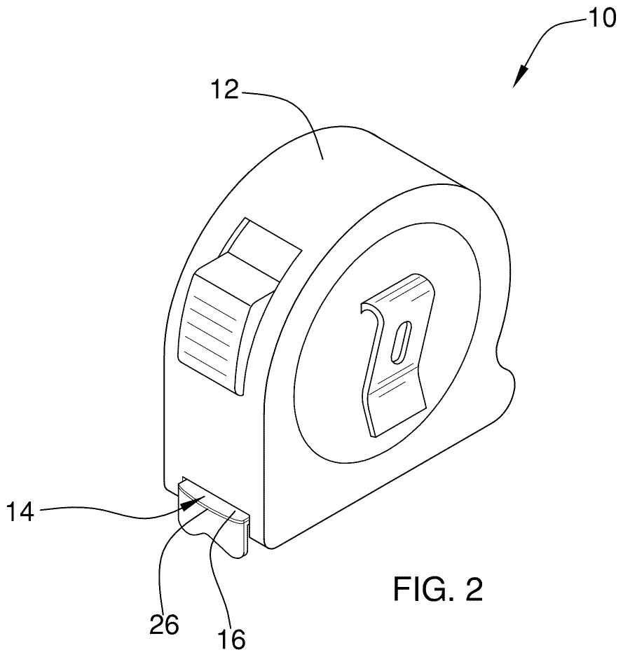

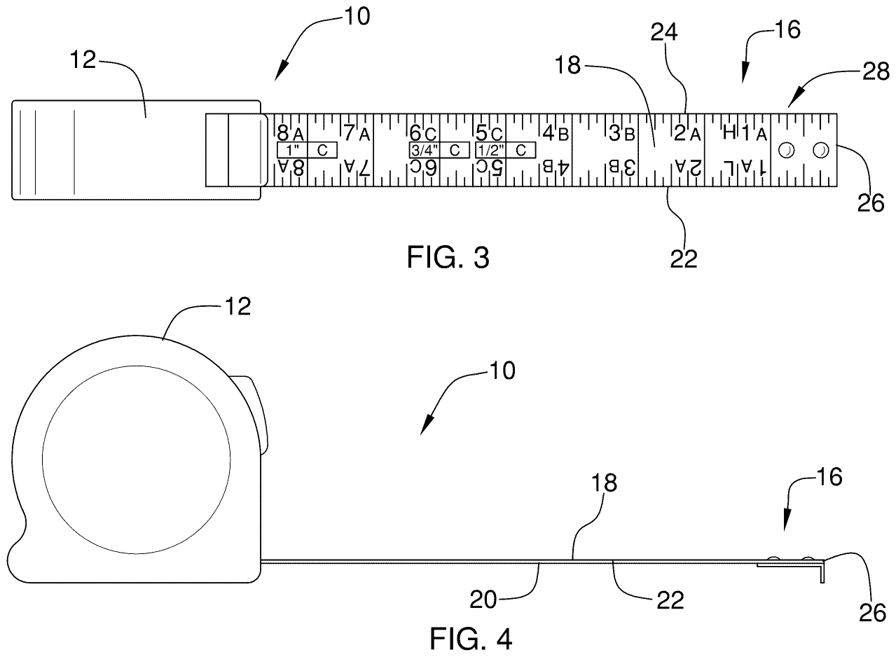

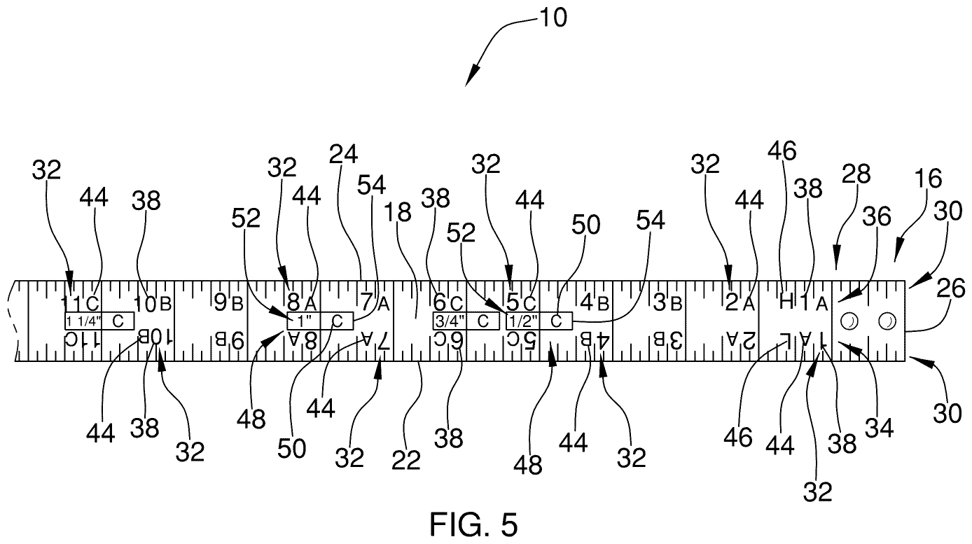

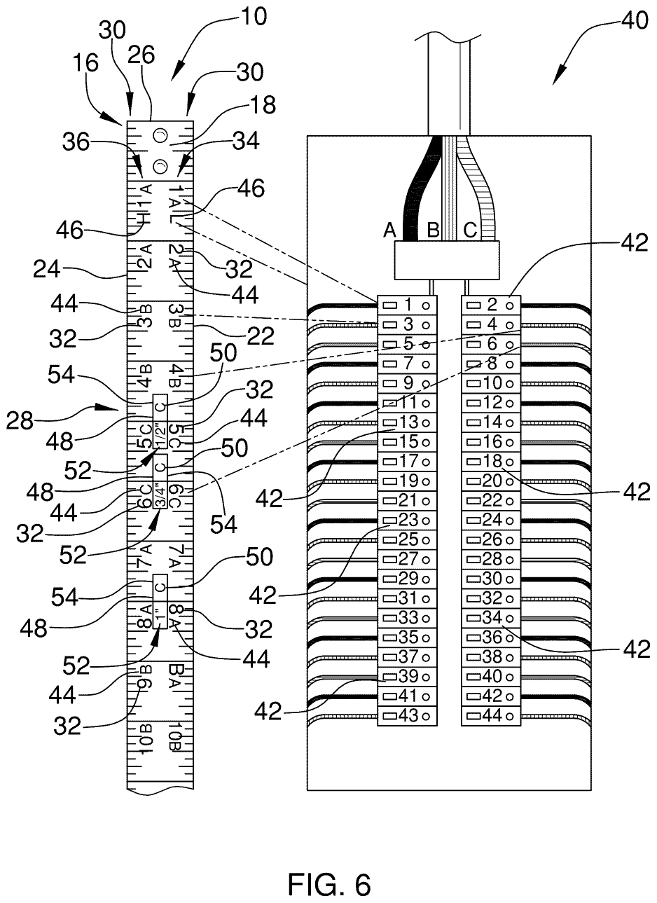

With reference now to the drawings, and in particular to FIGS. 1 through 7 thereof, a new measuring tool embodying the principles and concepts of an embodiment of the disclosure and generally designated by the reference numeral 10 will be described.

As best illustrated in FIGS. 1 through 6, the measuring device 10 generally comprises a case 12 which defines a slot 14 that extends into the case 12. A measuring tape 16 is mounted in the case 12 and may be stored in a wrapped or coiled arrangement. A torsion spring or other bias member may bias the measuring tape 16 to retract into the case 12. The measuring tape 16 is elongated and has a first surface 18 and a second surface 20 positioned opposite each other. The measuring tape 16 has a first longitudinal edge 22 and a second longitudinal edge 24 positioned opposite each other and has a free end 26 which extends between the first longitudinal edge 22 and the second longitudinal edge 24. The measuring tape 16 extends out of the case 12 through the slot 14 and is extendable away from the case 12 via the slot 14.

Measurement indicia 28 is coupled to the first surface 18 of the measuring tape 16 and is configured to indicate distances from the free end 26 of the measuring tape 16. The measurement indicia 28 include a plurality of numbers 32 and a plurality of graduations 30. The graduations 30 indicate precisely the portions of the measuring tape 16 which the numbers 32 refer to and subdivide the spaces between the numbers 32 to provide indications of fractional distances.

The plurality of numbers 32 includes a first subset 34 of numbers 32 and a second subset 36 of numbers 32. The numbers 32 of each of the first and second subsets 34, 36 of numbers 32 increase consecutively away from the free end 26 of the measuring tape 16. The numbers 32 of each of the first and second subsets 34, 36 of numbers 32 are evenly spaced with respect to each other and may be associated with distances measured in inches, centimeters, or any other suitable linear measure. The numbers 32 of the first subset 34 of numbers 32 are oriented such that a top end 38 of each number 32 of the first subset 34 of numbers 32 faces the first longitudinal edge 22 of the measuring tape 16. The numbers 32 of the second subset 36 of numbers 32 are oriented such that a top end 38 of each number 32 of the second subset 36 of numbers 32 faces the second longitudinal edge 24 of the measuring tape 16.

The numbers 32 are also color coded as a reference to intended wire colors used for a plurality of circuits 42 of an electrical panel 40. The numbers 32 of the first subset 34 of numbers 32 are colored in a repeated pattern of two numbers 32 in a first color, two numbers 32 in a second color, and two numbers 32 in a third color. The first color of the first subset 34 of numbers 32 is black, the second color of the first subset 34 of numbers 32 is red, and the third color of the first subset 34 of numbers 32 is blue. The numbers 32 of the second subset 36 of numbers 32 are also colored in a repeated pattern of two numbers 32 in a first color, two numbers 32 in a second color, and two numbers 32 in a third color. The first color of the second subset 36 of numbers 32 is brown, the second color of the second subset 36 of numbers 32 is orange, and the third color of the second subset 36 of numbers 32 is yellow. Different colors or color patterns may be used in other embodiments for the first and second subsets 34, 36 of numbers 32. However, the standard for low-voltage electrical panels is consistent with the colors selected for the first subset 34 of numbers 32, and the standard for high-voltage electrical panels is consistent with the colors selected for the second subset 36 of numbers 32.

The colors indicate which phase is intended to be electrically connected to the circuit 42 of an associated electrical panel 40 which is numbered with a matching number to that of the given number 32 of the measurement indicia 28. This code is further reinforced by phase indicia 44, which is also coupled to the first surface 18 of the measuring tape 16. The phase indicia 44 indicates an associated one of a first phase, a second phase, and a third phase for each number 32 of the first and second subsets 34, 36 of numbers 32. The phase indicia 44 includes a plurality of first phase indicia 44, a plurality of second phase indicia 44, and a plurality of third phase indicia 44. Each first phase indicium 44 is the letter “A,” each second phase indicium 44 is the letter “B,” and each third phase indicium 44 is the letter “C.” However, in other embodiments, other letters, symbols, graphical images, or the like may be used.

Each number 32 of the first and second subsets 34, 36 of numbers 32 has the first color of the first subset 34 of numbers 32 or the first color of the second subset 36 of numbers 32 is positioned adjacent to an associated first phase indicium 44 of the plurality of first phase indicia 44. Each number 32 of the first and second subsets 34, 36 of numbers 32 has the second color of the first subset 34 of numbers 32 or the second color of the second subset 36 of numbers 32 is positioned adjacent to an associated second phase indicium 44 of the plurality of second phase indicia 44. Each number 32 of the first and second subsets 34, 36 of numbers 32 has the third color of the first subset 34 of numbers 32 or the third color of the second subset 36 of numbers 32 is positioned adjacent to an associated third phase indicium 44 of the plurality of third phase indicia 44.

Voltage indicia 46 is also coupled to the first surface 18 of the measuring tape 16 and indicates to which type of electrical panel the colors of the first and second subsets 34, 36 of numbers 32 refer. The voltage indicia 46 comprises a low voltage indicium 46 and a high voltage indicium 46. The low voltage indicium 46 is positioned adjacent to the first subset 34 of numbers 32, and the high voltage indicium 46 is positioned adjacent to the second subset 36 of numbers 32. The low voltage indicium 46 is the letter “L,” and the high voltage indicium 46 is the letter, “H.” But the low voltage indicium 46 and the high voltage indicium 46 may comprise other letters, symbols graphical images, or the like in other embodiments.

Conduit bending indicia 48 is also coupled to the first surface 18 of the measuring tape 16. The conduit bending indicia 48 is configured to indicate associated arc lengths of electrical conduit of various sizes when bent using a conduit bender tool. The associated arc lengths may depend on the specific conduit bender tool used, and a selected conduit bender tool may be specified through further indicia or external instructions. Each conduit bending indicium 48 of the plurality of conduit bending indicia 48 is positioned at a distance from the free end 26 of the measuring tape 16 associated with the associated arc length of electrical conduit of a given size. The conduit bending indicia 48 are also positioned between the first subset 34 of numbers 32 and the second subset 36 of numbers 32.

Each conduit bending indicium 48 includes an identifying marking 50 (the letter “C”) and a size marking 52. The size marking 52 indicates the size of the associated electrical conduit which would have the indicated arc length (e.g., ¾″). Each conduit bending indicium 48 includes a box 54 which surrounds the identifying marking 50 and the size marking 52, and an associated one of the graduations 30 of the measurement indicia 28 extends through the box 54, indicating that the arc length indicated by the conduit bending indicium 48 is the length indicated by the associated graduation 30.

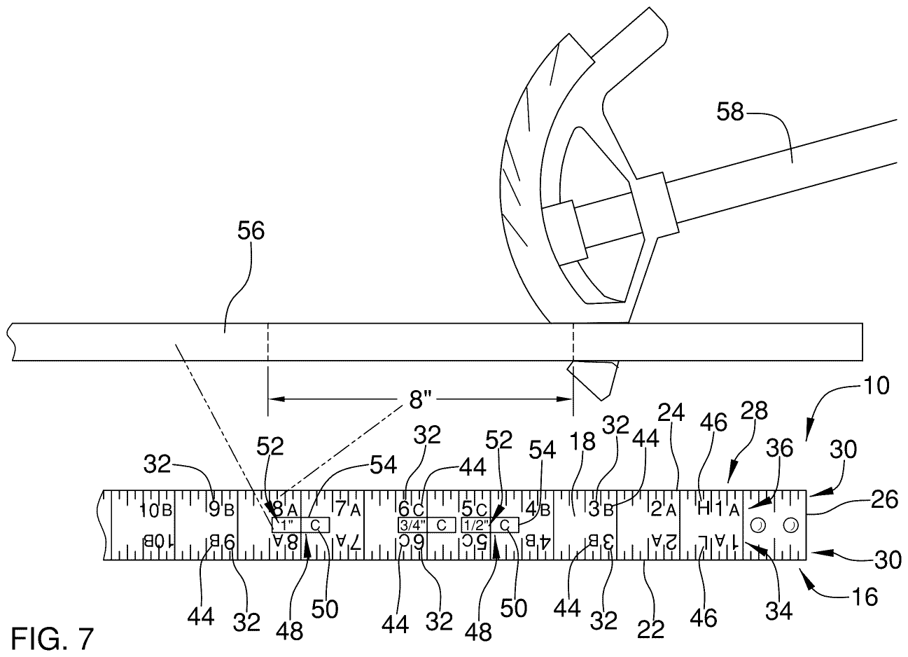

To further explain and as seen in FIG. 7, an exemplary conduit bending indicium 48 of the conduit bending indicia 48 includes the identifying marking 50 of the letter “C” to indicate that the indicium is, in fact, one of the conduit bending indicia 48. The exemplary conduit bending indicium 48 further includes the size marking 52 of “1″” to indicate that the exemplary conduit bending indicium 48 refers to an electrical conduit 56 having a diameter of 1 inch. The exemplary conduit bending indicium 48 is placed such that the graduation 30 that indicates 8 inches extends through the box 54 of the exemplary conduit bending indicium 48. These markings amount to indicating that a 1-inch electrical conduit 56 bent with a conduit bending tool 58 in a 90-degree bend would have an arc length through the bend of 8 inches.

In use, the measuring tape 16 may be used as is conventional to determine a length of a measured object using the measurement indicia 28. The colors of the numbers 32 and the phase indicia 44 communicate which color wire should be connected to an associated circuit 42 of the associated electrical panel 40 and which phase of electrical current should be passed through that circuit 42. The voltage indicia 46 indicate whether the colors of the given subset of numbers 32 refer to wire colors for a low-voltage electrical panel or a high-voltage electrical panel. The placement of the conduit bending indicia 48 communicates the arc length of an electrical conduit of a given diameter bent into a 90-degree bend using a conduit bending tool as described more fully above.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A measuring device comprising:
a measuring tape, the measuring tape being elongated, the measuring tape having a first surface and a second surface opposite each other, the measuring tape having a first longitudinal edge and a second longitudinal edge opposite each other, the measuring tape having a free end which extends between the first longitudinal edge and the second longitudinal edge; and
measurement indicia coupled to the first surface of the measuring tape, the measurement indicia including:
a plurality of numbers indicating distances from the free end of the measuring tape, the plurality of numbers including a first subset of numbers and a second subset of numbers, the numbers of each of the first and second subsets of numbers increasing consecutively away from the free end of the measuring tape;
wherein the numbers of the first subset of numbers are colored in a repeated pattern of two numbers in a first color, two numbers in a second color, and two numbers in a third color; and
wherein the numbers of the second subset of numbers are colored in a repeated pattern of two numbers in a first color, two numbers in a second color, and two numbers in a third color.

2. The measuring device of claim 1, wherein the first color of the first subset of numbers is black, the second color of the first subset of numbers being red, the third color of the first subset of numbers being blue.

3. The measuring device of claim 2, wherein the first color of the second subset of numbers is brown, the second color of the second subset of numbers being orange, the third color of the second subset of numbers being yellow.

4. The measuring device of claim 1, wherein the numbers of each of the first and second subsets of numbers are evenly spaced with respect to each other.

5. The measuring device of claim 1, wherein the numbers of the first subset of numbers are oriented such that a top end of each number of the first subset of numbers faces the first longitudinal edge of the measuring tape, the numbers of the second subset of numbers being oriented such that a top end of each number of the second subset of numbers faces the second longitudinal edge of the measuring tape.

6. The measuring device of claim 1 wherein the measurement indicia further includes a plurality of graduations indicating distances from the free end of the measuring tape.

7. The measuring device of claim 1, further comprising phase indicia coupled to the first surface of the measuring tape, the phase indicia indicating an associated one of a first phase, a second phase, and a third phase for each number of the first and second subsets of numbers, the phase indicia including:
a plurality of first phase indicia, wherein each number of the first and second subsets of numbers having the first color of the first subset of numbers or the first color of the second subset of numbers is positioned adjacent to an associated first phase indicium of the plurality of first phase indicia;
a plurality of second phase indicia, wherein each number of the first and second subsets of numbers having the second color of the first subset of numbers or the second color of the second subset of numbers is positioned adjacent to an associated second phase indicium of the plurality of second phase indicia; and
a plurality of third phase indicia, wherein each number of the first and second subsets of numbers having the third color of the first subset of numbers or the third color of the second subset of numbers is positioned adjacent to an associated third phase indicium of the plurality of third phase indicia.

8. The measuring device of claim 1, further comprising voltage indicia coupled to the first surface of the measuring tape, the voltage indicia comprising a low voltage indicium and a high voltage indicium, the low voltage indicium being positioned adjacent to the first subset of numbers, the high voltage indicium being positioned adjacent to the second subset of numbers.

9. The measuring device of claim 1, further comprising conduit bending indicia coupled to the first surface of the measuring tape, the conduit bending indicia being configured to indicate associated arc lengths of electrical conduit of various sizes, each conduit bending indicum of the plurality of conduit bending indicia being positioned at a distance from the free end of the measuring tape associated with the associated arc length of electrical conduit of a given size.

10. The measuring device of claim 1, further comprising a case, the case defining a slot which extends into the case, the measuring tape being mounted in the case, the measuring tape extending out of the case through the slot, the measuring tape being extendable away from the case via the slot.

11. A measuring device comprising:
a case, the case defining a slot which extends into the case;
a measuring tape mounted in the case, the measuring tape being elongated, the measuring tape having a first surface and a second surface opposite each other, the measuring tape having a first longitudinal edge and a second longitudinal edge opposite each other, the measuring tape having a free end which extends between the first longitudinal edge and the second longitudinal edge, the measuring tape extending out of the case through the slot, the measuring tape being extendable away from the case via the slot;
measurement indicia coupled to the first surface of the measuring tape, the measurement indicia including:
a plurality of numbers indicating distances from the free end of the measuring tape, the plurality of numbers including a first subset of numbers and a second subset of numbers, the numbers of each of the first and second subsets of numbers increasing consecutively away from the free end of the measuring tape, the numbers of each of the first and second subsets of numbers being evenly spaced with respect to each other, the numbers of the first subset of numbers being oriented such that a top end of each number of the first subset of numbers faces the first longitudinal edge of the measuring tape, the numbers of the second subset of numbers being oriented such that a top end of each number of the second subset of numbers faces the second longitudinal edge of the measuring tape;
wherein the numbers of the first subset of numbers are colored in a repeated pattern of two numbers in a first color, two numbers in a second color, and two numbers in a third color, the first color of the first subset of numbers being black, the second color of the first subset of numbers being red, the third color of the first subset of numbers being blue;
wherein the numbers of the second subset of numbers are colored in a repeated pattern of two numbers in a first color, two numbers in a second color, and two numbers in a third color, the first color of the second subset of numbers being brown, the second color of the second subset of numbers being orange, the third color of the second subset of numbers being yellow; and
a plurality of graduations indicating distances from the free end of the measuring tape;
phase indicia coupled to the first surface of the measuring tape, the phase indicia indicating an associated one of a first phase, a second phase, and a third phase for each number of the first and second subsets of numbers, the phase indicia including:
a plurality of first phase indicia, wherein each number of the first and second subsets of numbers having the first color of the first subset of numbers or the first color of the second subset of numbers is positioned adjacent to an associated first phase indicium of the plurality of first phase indicia;
a plurality of second phase indicia, wherein each number of the first and second subsets of numbers having the second color of the first subset of numbers or the second color of the second subset of numbers is positioned adjacent to an associated second phase indicium of the plurality of second phase indicia; and
a plurality of third phase indicia, wherein each number of the first and second subsets of numbers having the third color of the first subset of numbers or the third color of the second subset of numbers is positioned adjacent to an associated third phase indicium of the plurality of third phase indicia;
voltage indicia coupled to the first surface of the measuring tape, the voltage indicia comprising a low voltage indicium and a high voltage indicium, the low voltage indicium being positioned adjacent to the first subset of numbers, the high voltage indicium being positioned adjacent to the second subset of numbers; and
conduit bending indicia coupled to the first surface of the measuring tape, the conduit bending indicia being configured to indicate associated arc lengths of electrical conduit of various sizes, each conduit bending indicum of the plurality of conduit bending indicia being positioned at a distance from the free end of the measuring tape associated with the associated arc length of electrical conduit of a given size.
